(19) United States
(12) Patent Application Publication
(10) Pub. No.: US 2014/0320367 A1
(43) Pub. Date: Oct. 30, 2014

(54) SMALL PRINTED MEANDER ANTENNA PERFORMANCES IN 315MHz FREQUENCY BAND INCLUDING RF CABLE EFFECT

(71) Applicants: Basim Alkhateeb, Hatem-Irbid (JO); Abualkhair M. Alkhateeb, Auburnhills, MI (US)

(72) Inventors: Basim Alkhateeb, Hatem-Irbid (JO); Abualkhair M. Alkhateeb, Auburnhills, MI (US)

(73) Assignee: KING ABDULLAH II DESIGN AND DEVELOPMENT BUREAU, Amman (JO)

(21) Appl. No.: 13/872,528

(22) Filed: Apr. 29, 2013

(51) Int. Cl. H01Q 9/26

(52) U.S. Cl. CPC H01Q 9/26
USPC 343/804

(57) ABSTRACT

The present disclosure pertains to a compact antenna assembly adapted to be used with a remote key entry system for an associated vehicle that is configured to receive radio waves within the 200 MHz to 450 MHz frequency band or more particularly within about the 315 MHz band. The antenna assembly includes a meander line antenna trace of a desired geometry having a plurality of bends and strips that is configured to reduce the effect of electromagnetic interference. A dielectric substrate is configured to receive the antenna trace along a surface thereon wherein the dielectric substrate and antenna trace is installed within an associated housing that is generally compact and configured to be installed within the associated vehicle. The geometry of the meander line antenna trace is configured in either a symmetrical dipole antenna or an asymmetrical antenna. An RF cable can be attached to the antenna.

### BACKGROUND

The present disclosure relates to printed meander dipole antenna for automotive applications, which increases short-range wireless detection in the 200 MHz to 450 MHz frequency band. It finds particular application in conjunction with a compact printed meander dipole antenna with a radio frequency (RF) cable that is easily manufactured and has a reduced size. This compact dipole has an advantage over currently available antennas because it can be hidden within the interior portions of a vehicle with minimum RF cable effect on the antenna performance and will be described with particular reference thereto. However, it is to be appreciated that the present exemplary embodiment is also amenable to other like applications.

Generally, embedded antenna as a rule is printed on a dielectric board together with electronic components of a remote keyless entry (RKE) system within a housing. The integration of the RF cable and digital electronic components with a receiving antenna reduces the number of wires and connectors and therefore provides a cost reduction of the whole system. However, the communication range of the antenna can be dramatically reduced due to parasitic emissions of the electronic components that are received by the antenna within the RKE system.

External dipole or whip style antennas do not experience this disadvantage because they are isolated from the control electronics elements. However, external dipole and monopole antennas are large and designed to be located on the exterior of the vehicle. Therefore, these antennas are inconvenient for interior vehicle applications.

Planar printed meander line small size external antenna is a promising design for extended range automotive applications such as RKE systems. The meander line antenna is well known and can achieve high efficiency with very small size. It is known that small size asymmetrical external printed on FR4 dielectric antenna for interior application is investigated in the technical paper by B. Al-Khateeb, V. Rabinovich, and B. Oakley, An active receiving antenna for short-range wireless automotive communication, Microwave Opt Technol Lett 44 (2004), 200-205. It was shown that a suggested geometry induces significant current flow by utilizing an outer conductor of the RF cable that connects an antenna with an RKE control module. The RF cable becomes a part of an antenna and therefore cable location affects the communication range of the RKE system.

Modern vehicles are equipped with many different electronic devices such as an air condition module with automatic temperature control, an audio amplifier system, a heated seat module, a power control module, a sun roof module, etc. These electronic devices can produce parasitic near-field emissions that can interfere with the routing path of a signal received by the RF cable and thereby reduce the communication range of the RKE system. Electromagnetic compatibility (EMC) measurements show that such interference emission can exceed the noise floor level of the RKE system by a value of more than 20 dB. In one embodiment of an RKE system, the nominal communication range is equal to approximately 100 meters in the absence of parasitic emissions. However, in the presence of emissions interference, RF cable noise that exceeds the noise floor of the RKE by 20 dB can reduce the communication range to below 20 meters or less.

It is known that the addition of a typical marchhand balun can be utilized for excluding cable effect antenna See Pugilia K. C. “Application Notes: Electromagnetic simulation of some common balun structures,” IEEE Microwave Magazine, September 2002, pp 56-61. An antenna printed on a circuit board having a balun has a linear size equal a quarter of the wave length and is therefore too large for 315 MHz rated automotive hidden applications. Therefore, there is a need for an antenna that has small size, high efficiency, and minimal cable effect on antenna performances. There is interest to identify the relationship between the RF cable on an antenna assembly with symmetrical and asymmetrical antenna structures.

Therefore, there remains a need for an antenna system and method that will provide a printed meander dipole antenna for use on the 315 MHz spectrum that can reduce the effects of emissions interference from electromagnetic devices. It is desirable to provide an antenna assembly with a small size that can avoid unwanted reduction in communication ranges commonly caused by known systems and methods of radio frequency communication along the 315 MHz spectrum.

### BRIEF DESCRIPTION

In one embodiment the present disclosure pertains to a compact antenna assembly adapted to be used with a remote key entry system for an associated vehicle that is configured to receive radio waves within the 200 MHz to 450 MHz frequency band. More particularly, the frequency band is about 315 MHz. The antenna assembly includes a meander line antenna trace of a desired geometry having a plurality of bends and strips that is configured to reduce the effect of electromagnetic interference. A dielectric substrate is configured to receive the antenna trace along a surface thereon wherein the dielectric substrate and antenna trace is installed within an associated housing that is generally compact and configured to be installed within the associated vehicle.

In one embodiment, the geometry of the meander line antenna trace is configured in a symmetrical dipole antenna. The bends and strips of the symmetrical dipole antenna are configured such that the addition of an RF cable does not have a significant effect on the performance of the antenna.

In another embodiment, the geometry of the meander line antenna trace is configured in an asymmetrical antenna. The bends and strips of the asymmetrical antenna are configured such that the addition of an RF cable does have a significant effect on the performance of the antenna.

### BRIEF DESCRIPTION OF THE DRAWINGS

The present disclosure may take form in certain parts and arrangements of parts, several embodiments of which will be described in detail in this specification and illustrated in the accompanying drawings which form a part hereof and wherein:

FIG. 1A is a plan view of a first embodiment of a symmetrical meander dipole antenna of the present disclosure;

FIG. 1B is a plan view of a second embodiment of the symmetrical meander dipole antenna of the present disclosure;

FIG. 1C is a plan view of a third embodiment of the symmetrical meander dipole antenna of the present disclosure;

FIG. 1D is a plan view of an asymmetrical meander dipole antenna of the present disclosure;

FIG. 1E is a plan view of the symmetrical meander dipole antenna of FIG. 1A with a ground spot and an RF cable;

FIG. 2 is a table that illustrates the calculated results of a simulation conducted on electromagnetic software;

FIG. 3 is a graph displaying a calculated antenna directionality for the symmetrical antenna of FIG. 1A;

FIG. 4 is a graph displaying a calculated antenna directionality for the symmetrical antenna of FIG. 1B;

FIG. 5 is a graph displaying a calculated antenna directionality for the symmetrical antenna of FIG. 1C;

FIG. 6 is a graph displaying a calculated antenna directionality for the symmetrical antenna of FIG. 1E;

FIG. 7 is a graph displaying a calculated antenna directionality for the asymmetrical antenna of FIG. 1D;

FIG. 8 is a graph displaying a calculated antenna directionality for the asymmetrical antenna of FIG. 1D with an RF cable;

FIG. 9 is a graph displaying a calculated antenna directionality for the asymmetrical antenna of FIG. 1D with an RF cable that has a different length than the RF cable of FIG. 8;

FIG. 10 is a graph displaying a calculated antenna directionality for the asymmetrical antenna of FIG. 1D with an RF cable that has a different length than the RF cable of FIGS. 8 and 9;

FIG. 11 is a graph that compares the calculated ratio between an efficiency and an RF cable length for the asymmetrical antenna of FIG. 1D;

FIG. 12 is a table that illustrates the calculated results of a mean square error of the symmetrical antennas of FIGS. 1A, 1B, 1C and 1E and the asymmetrical antenna of FIG. 1D;

FIG. 13 is a graph displaying a measured antenna directionality for the symmetrical antenna of FIG. 1A;

FIG. 14 is a graph displaying a measured antenna directionality for the symmetrical antenna of FIG. 1A with an RF cable with a length of 65 cm;

FIG. 15 is a graph displaying a measured antenna directionality for the symmetrical antenna of FIG. 1A with an RF cable with a length of 1 m;

FIG. 16 is a graph displaying a measured antenna directionality for the symmetrical antenna of FIG. 1A with an RF cable with a length of 1.5 m;

FIG. 17 is a graph displaying a measured antenna directionality for the symmetrical antenna of FIG. 1E with an RF cable with a length of 1 m;

FIG. 18 is a graph displaying a measured antenna directionality for the asymmetrical antenna of FIG. 1D;

FIG. 19 is a graph displaying a measured antenna directionality for the asymmetrical antenna of FIG. 1D with an RF cable with a length of 65 cm;

FIG. 20 is a graph displaying a measured antenna directionality for the asymmetrical antenna of FIG. 1D with an RF cable with a length of 1 m; and

FIG. 21 is a graph displaying a measured antenna directionality for the asymmetrical antenna of FIG. 1D with an RF cable with a length of 1.5 m.

### DETAILED DESCRIPTION

It is to be understood that the detailed figures are for purposes of illustrating exemplary embodiments of the present disclosure only and are not intended to be limiting. Additionally, it will be appreciated that the drawings are not to scale and that portions of certain elements may be exaggerated for the purpose of clarity and ease of illustration.

Disclosed is a symmetrical meandered dipole antenna with reduced linear size that is compatible with 315 MHz automotive applications. However, the disclosed antenna can be used in many short range applications (such as security, monitoring, and wireless control systems in the band (200 MHz to 450 MHz)) where the performance requirements are similar to those described. The antenna includes a plurality of bends and strips and is printed on a dielectric board. The dielectric board has a generally small size and can be housed within the interior portions of the car that can be hidden from view. Disclosed are various antenna geometries including a symmetrical meander dipole and asymmetrical meander line antenna. Those that include a radio frequency (RF) cable are without a balun.

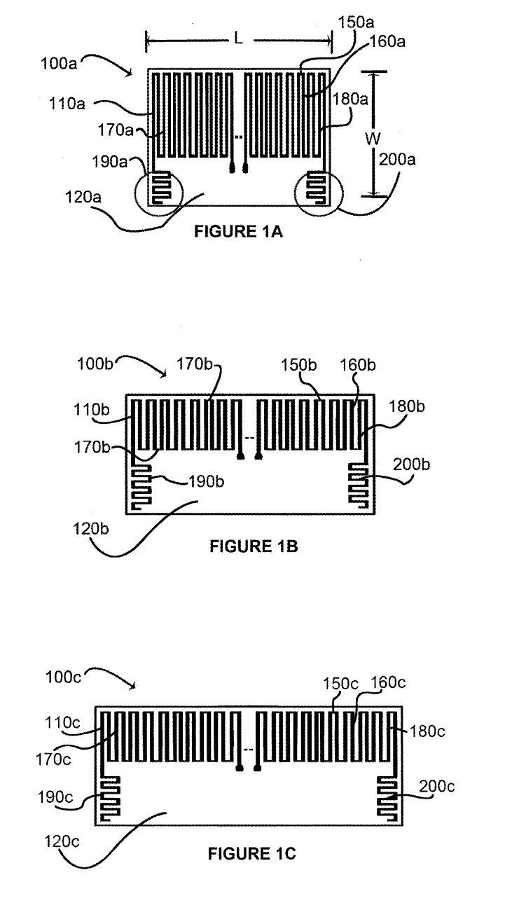

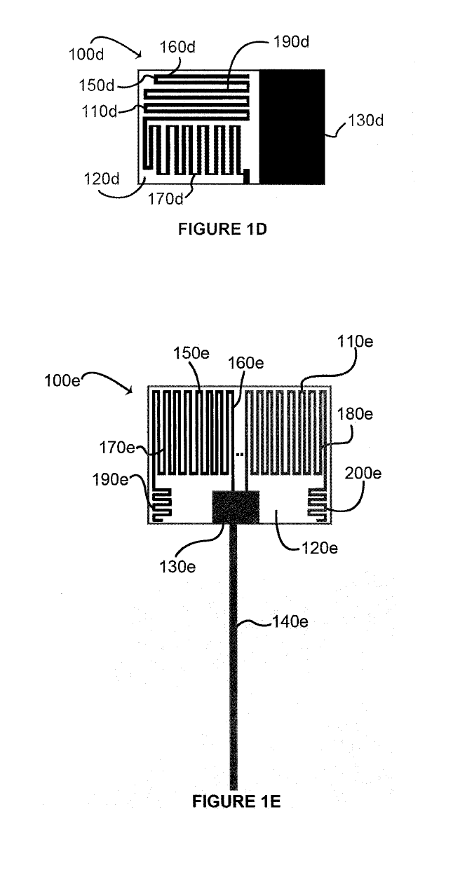

FIGS. 1A-1E illustrates meander line antennas 100a-100e with several different linear sizes of various lengths (L) and widths (W). FIGS. 1A-1C disclose symmetrical dipole geometries 100a, 100b, 100c wherein the length of the antenna 100c in FIG. 1C is greater than the length of the antennas 100a, 100b of FIGS. 1A and 1B, but still less than 1/10 the length of a radio wave signal. FIG. 1D illustrates an asymmetrical meander line antenna 100d with the same linear sizes L and W as the antenna 100a shown in FIG. 1A. The ratio W/L for each antenna is less than 1. In one embodiment, each of the antenna assemblies 100a-100e include a meander line antenna trace 10a-110e that is made of a conductive material that is printed on one side of a dielectric substrate 120a-120e such as a FR4 type substrate. In one embodiment, the dielectric substrate includes a thickness of 1.6 mm and a relative permittivity of 4.4. The width of meander line antenna trace lines are approximately 1 mm. Antennas 100d and 100e presented in FIGS. 1D and 1E include a ground spot 130d, 130e which can be used as a ground for an amplifier circuit when the antenna is used with an active receiving design. The antenna 100e illustrated by FIG. 1E includes an RF cable 140. The unoccupied spaces on the dielectric substrates 120a-120e can be used to include electronic components for an active antenna design (such as an amplifier circuit, components to digitize the signal, etc.). Additionally, this unoccupied space can include a receiving circuit that is configured to receive a demodulated signal.

The total printed meander line length includes a plurality of bends 150a-150e and strips 160a-160e. The symmetrical meander dipole antennas include a first trace arm 170a, 170b, 170c and 170e and an opposing second trace arm 180a, 180b, 180e and 180e that symmetrically extend along the dielectric substrate relative to each other. Additionally, each symmetrical meander dipole antenna includes a first trace projection 190a, 190b, 190c, and 190e that extends from the first trace arm 170a, 170b, 170c and 170e, respectively and an opposing second trace projection 200a, 200b, 200c, and 200e that extends form the second trace arm 180a, 180b, 180c and 180e wherein the first trace projections and the second trace projections are generally symmetrical aligned to each other along the dielectric substrate. The geometries of the first trace projections 190a, 190b, 190c and 190e and the second trace projections 200a, 200b, 200c and 200e are oriented in the illustrated configuration to increate radiation resistance and directionality of signal reception which increases gain and enhances the performance efficiency of the symmetrical arms and decreases the cable effect.

The asymmetrical meander dipole antenna 100d includes a trace arm 170d and a trace projection 190d that extends from the trace arm 170d. The trace arm 170d and trace projection 190d extend substantially along the dielectric substrate 1204.

The number of bends 150a-150e and the length for each strip 160a-160e for each antenna 100a-100e has been selected using electromagnetic software IE3D to provide an impedance of approximately 50-Ω. Accurate tuning to the 50-Ω impedance was achieved experimentally by positioning an inductor between a positive and a negative dipole arm of the antenna. Meander asymmetrical antenna impedance tuning to 50-Ω was provided by an additional capacitor (not shown). All antennas are intended to be used with an external antenna connected with a control RKE module through the RF cable.

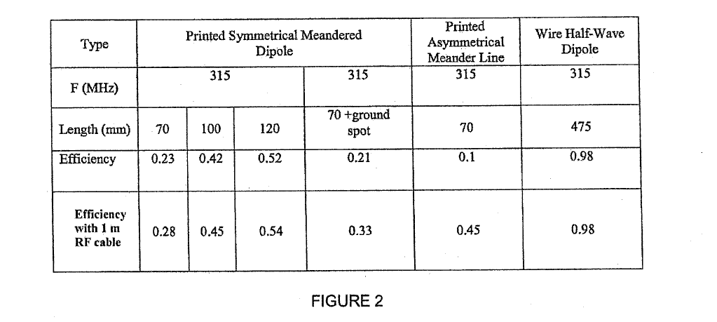

Radiation efficiency and directionality of the various antennas were investigated using IE3D electromagnetic software. FIG. 2 identifies the simulation results of the radiation efficiency r of the antennas without and with RF cable, and antenna directionality without and with RF cable. FIG. 2 shows the results of the simulation of the radiation efficiency TI for different linear antenna sizes. As it can see from the table of FIG. 2, printed asymmetrical meander line antenna without RF cable has the lowest antenna efficiency value equal 0.1 (−10 dB). Printed symmetrical meander dipole antenna is more efficient (2.3 times more than the printed asymmetrical meander line antenna). The table also shows that the 70 mm linear sized asymmetrical meander antenna with a 1 m RF cable has a comparable efficiency with the 100 mm linear sized meandered dipole without the RF cable. The value supports that the asymmetrical meander cable becomes a significant antenna part. Additionally, the difference between the efficiency of the symmetrical meander dipole antenna with and without the RF cable is generally insignificant. The addition of the ground spot does not drastically change the dipole efficiency.

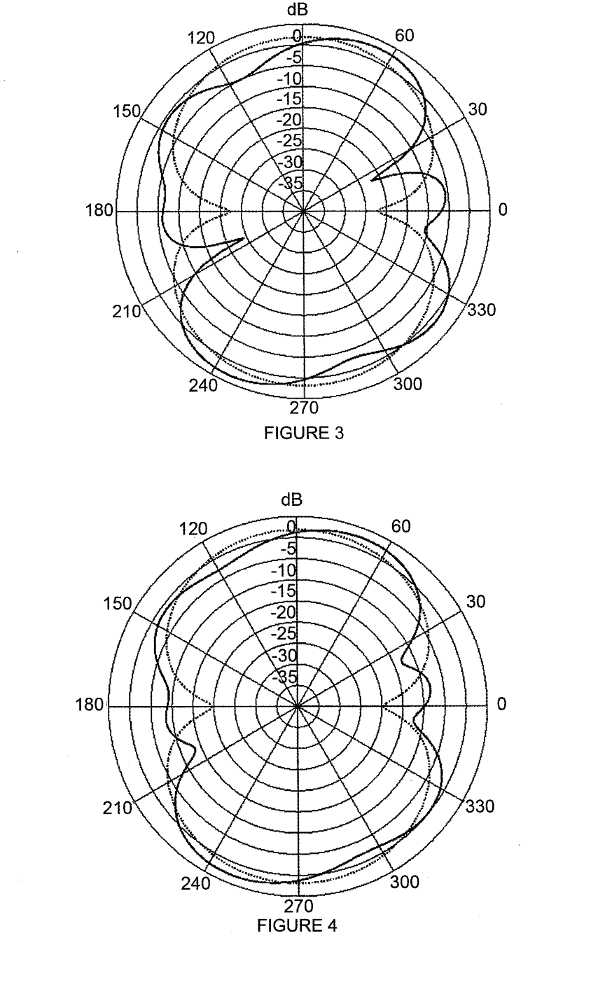

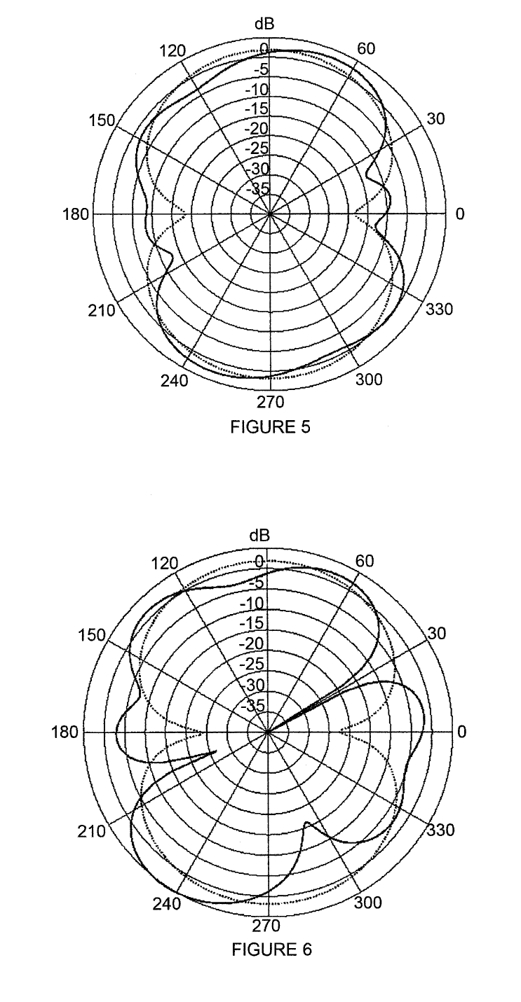

Antenna directionality for the designs illustrated by FIGS. 1A, 1B, 1C, and 1E, each attached to an RF cable having a length of 1 m is shown by FIGS. 3, 4, 5 and 6 respectively. Dashed lines shown in all figures correspond to the directionality calculated without the RF cable. Solid lines shown in all figures correspond to the directionality calculated with the RF cable.

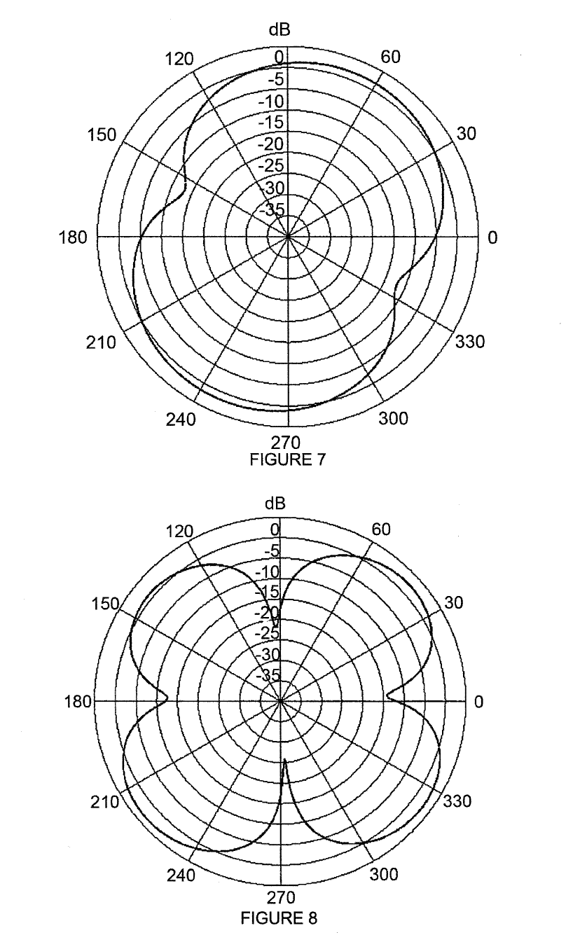

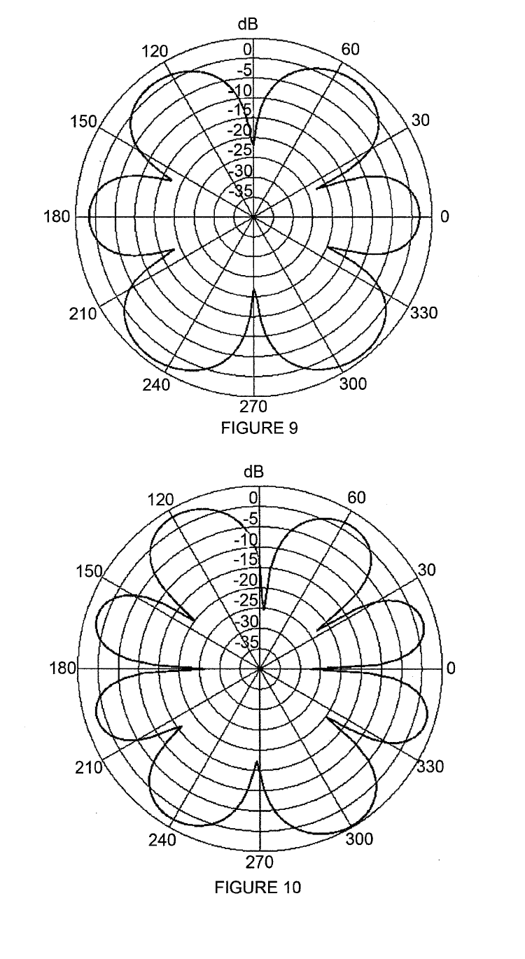

FIG. 7 shows calculated antenna directionality for the asymmetrical antenna without RF cable of FIG. 1D. FIGS. 8 to 10 show calculated directionalities for the asymmetrical antenna with the RF cable of different lengths. The presented figures from FIGS. 8 to 10 illustrate that the meander line antenna with RF cable length is equivalent to the symmetrical dipole with the total length that provides more than two directionality lobes (total length is more than ¾ of the wave length).

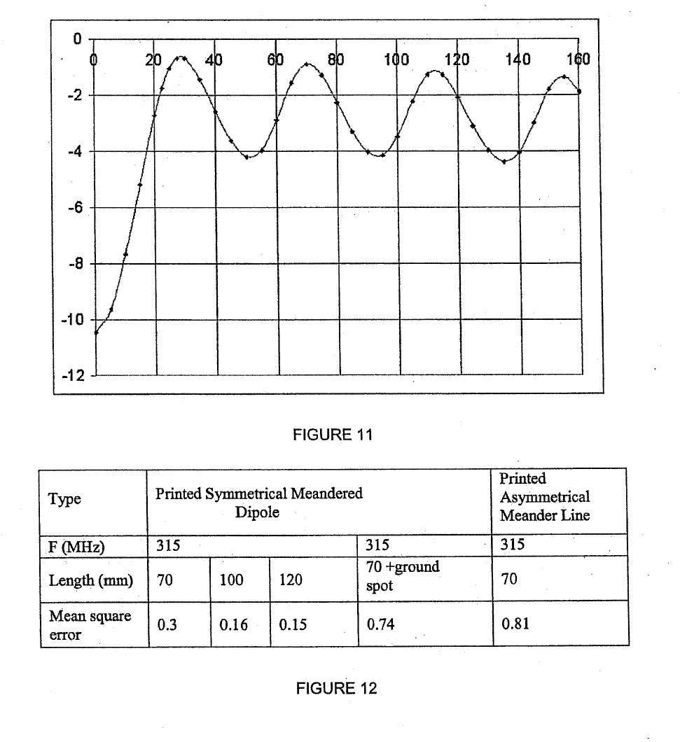

FIG. 11 is a graph that shows the calculated ratio between the efficiency η and RF cable length for the asymmetrical meander antenna shown in FIG. 1d. Efficiency expressed in dB format is normalized to the half wave dipole efficiency.

The asymmetrical antenna with a 25 cm RF cable is almost equivalent to a half wave dipole. This result is very similar to the results for coaxial antennas as reported by technical papers by B. Drozd and W. T. Joines, “Comparison of Coaxial Dipole Antennas for Applications in the Near-field and Far field Regions,” Microwave Journal, May 2004 and S. Saaro, D. V. Thiel, J. W. Lu, and S. G. o Keefe, “An Assessment of Cable Radiation Effects on Mobile Communications Antenna Measurements,” IEEE Antennas Propagat. Symp., Columbus, Ohio, pp. 439-442, June 1997. Each paper is incorporated herein for reference.

Generally, coaxial antenna is made by simply stripping off an outer conductor to extend the inner conductor by a quarter-wavelength. Such antenna is almost equivalent to a half wave dipole. The antenna of the present disclosure includes an inner conductor that is a meander line with linear size much less than a quarter wave length but with a total trace length more than a quarter wave length.

The “similarity” between two power directionality curves can be estimated with equation (1) below wherein the first curve F (θ) corresponds to the antenna without the RF cable and the second curve f(θ) corresponds to the antenna with the RF cable. This comparison introduces an average over 360 degrees mean square error parameter ∈.

$$ɛ = \frac{{\int }_{0}^{360} {( F ( θ ) - f ( θ ) )}^{2} d θ}{{\int }_{0}^{360} {F}^{2} ( θ ) d θ} \qquad ( 1 )$$

FIG. 12 illustrates the calculated results wherein the mean square error ∈ approximately determines the percentage of the electromagnetic signal that is received by the RF cable (compared to the antenna itself). Notably, FIG. 12 shows that the “worth” design from a similarity point of view is the printed asymmetrical antenna (has maximum cable effect) and the “best” design is the symmetrical antenna.

The measurement procedure includes placing the passive meander line dipole antenna printed on an FR-4 dielectric substrate in a generally horizontal plane on a turn table. The substrate plane is placed generally parallel to the floor plane. The antenna is set to operate in a transmitting mode. A horizontally polarized Yagi antenna is set to operate in a receiving mode within frequency range from 300 MHz to 1000 MHz. The Yagi antenna is located in the far zone of the antenna assembly (passive antenna under test with the RF cable). Directionality measurements are taken and results are presented over 360 degrees in the horizontal plane for the horizontal polarization. For measurements taken in this embodiment, an RG 174 type RF cable is utilized with losses equal to approximately 0.5 dB per 1 m in the 315 MHz frequency band and 0.7 dB in the 433.9 MHz frequency band.

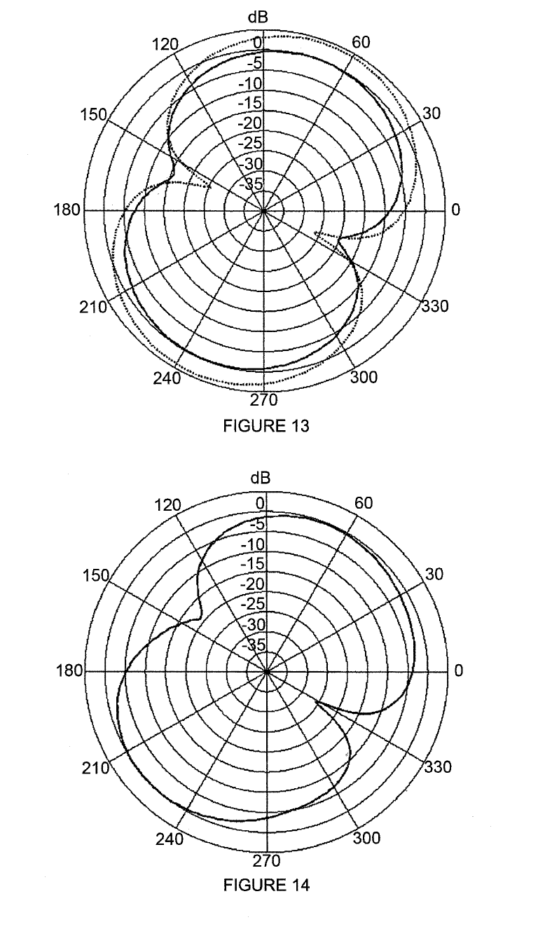

The measurement results for the symmetrical meander dipole shown in FIG. 1A are presented in FIGS. 13 to 16. All figures demonstrate the horizontal polarization directionality plots in the azimuth plane for an antenna assembly that includes a meander line antenna with different lengths of the RG 174 type RF cable.

FIG. 13 reveals antenna directionality of the meander dipole without the RF cable (solid line) and a reference antenna (dashed line). The average over 360 degrees gain of the printed dipole is less than the gain of the reference antenna by the value equal −4 dB.

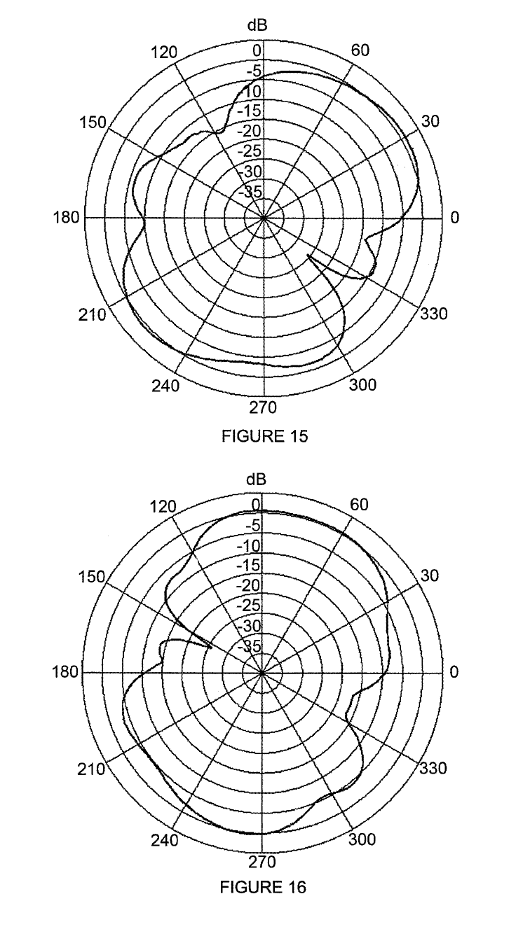

FIG. 14 reveals antenna directionality with the RF cable length equal to one cable wave length (approximately 65 cm). FIG. 15 reveals antenna directionality with the RF cable length of 1 m and FIG. 16 corresponds to the antenna assembly with the RF cable length of 1.5 m. FIG. 17 demonstrates antenna directionality of the antenna with a ground spot and 1 m RF cable.

The measurement results confirm the numerical simulation results disclosed by the IE3d electromagnetic software. More particularly, it can be stated that the RF cable effect is not very significant on the performances of the symmetrical antennas. The symmetrical meandered dipole antenna with L=100 mm and the antenna with L=120 mm reveal a similar level of agreement between the simulation and measured results.

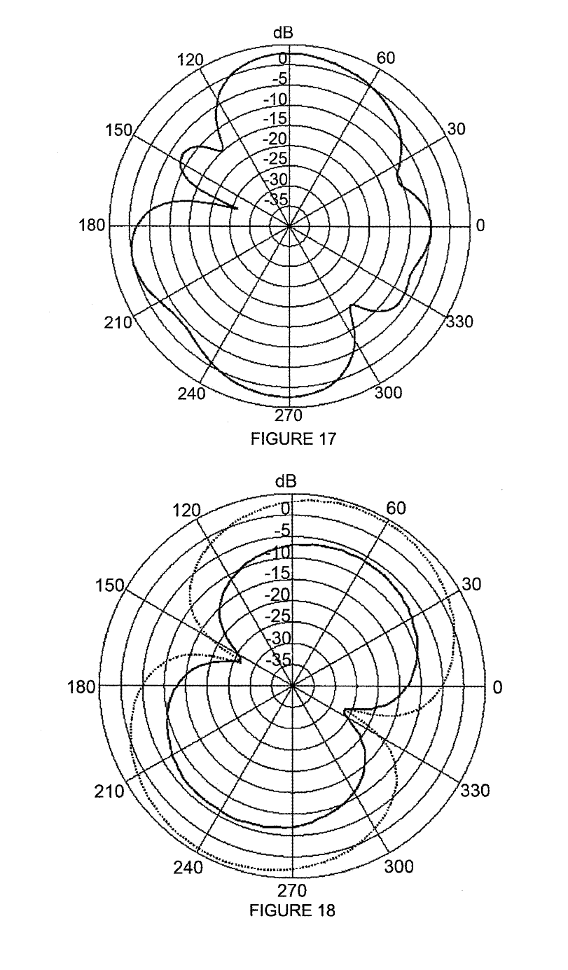

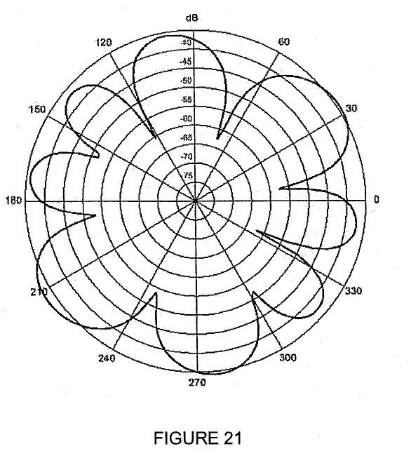

FIGS. 18 to 21 illustrate the horizontal polarization directionality plots in the azimuth plane for an antenna assembly that includes the asymmetrical meander line antenna with the RG 174 type RF cable.

FIG. 18 reveals the 315 MHz meandered printed dipole antenna with L=70 mm without an RF cable (solid line) and a reference half wave dipole antenna (dashed line). Average over 360 degrees gain of the printed antenna is approximately equal to −10 dB compared to the reference dipole.

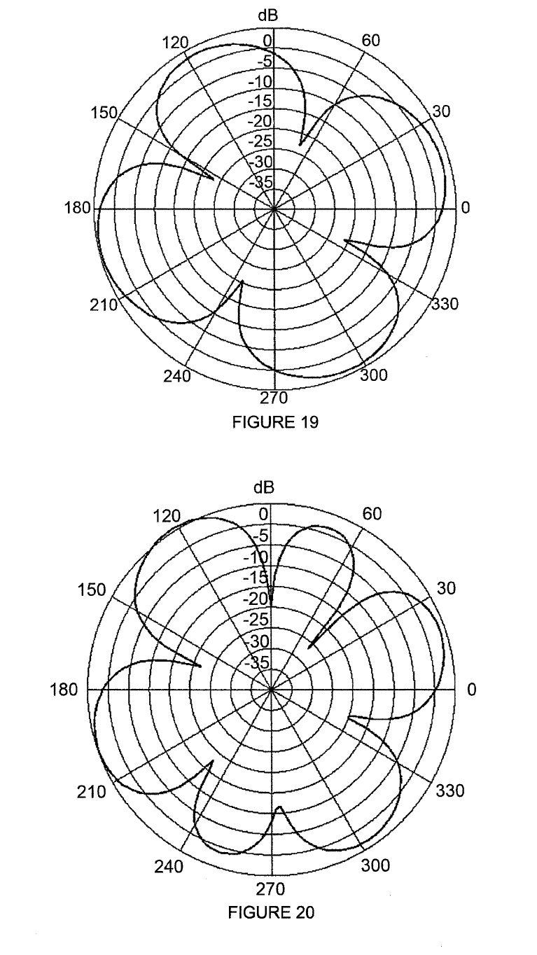

FIG. 19 presents the measurement results of an asymmetrical antenna with the RF cable with a length of 65 cm (one wave length) wherein there exist 4 main lobes in lieu of 2 main lobes. FIG. 2 shows the antenna directionality wherein the RF cable length is equal to 1 m and FIG. 21 is the experimental result for the RF cable length equal to 1.5 m. These FIGS. 18-21 illustrate a similar level of agreement between the simulation and measurement results. It is revealed that the RF cable does significantly affect the performances of the asymmetrical antennas.

The printed meander dipole antenna design with reduced size in 315 MHz frequency band for RKE automotive applications. Investigated antennas have less than 1/10 of the wave length size, high efficiency (not less than −4 dB) compare to the half wave dipole, minimum cable effect on the antenna performances, and used as a hidden antennas for the automotive RKE application. As illustrated by FIG. 2, the linear size of the antenna can be increased (from 70 mm to 120 mm) that does not drastically increase the antenna gain and therefore the communication range.

The effect of the RF cable on the non-symmetrical meander antenna increases the gain by increasing radiation resistance, directivity and reducing images of the printed circuit board antennas. The number of strips and bends and the spaces therebetween are related to the cable effect that enhances the antenna's performance, especially in a noisy environment when the antenna is surrounded by many electrical devices that emit wide band noise. Due to the lack of substantial effect of the various lengths of the RF cable connected to the symmetrical meander dipole antennas, there are broad design choices available to identify a proper application that does not affect receiving performance. By changing the number of strip lines, turns, dimensions, spaces, distances between the loops, size of the meander strip lines; the overall performance of the antenna would change related to the RF cable effect.

The exemplary embodiments of the disclosure have been described herein. Obviously, modifications and alterations will occur to others upon reading and understanding the preceding detailed description. It is intended that the instant disclosure can be construed as including all such modifications and alterations insofar as they come within the scope of the appended claims or the equivalents thereof.

1. A compact antenna assembly for a remote key entry system for an associated vehicle that is adapted to receive radio waves within the 200 MHz-450 Mhz frequency band, the antenna assembly comprising:
a meander line antenna trace of a desired geometry having a plurality of bends and strips that is configured to reduce the effect of electromagnetic interference; and
a dielectric substrate includes a length (L) and a width (W) that is configured to receive the antenna trace along a surface thereon;
wherein the dielectric substrate and antenna trace is can be installed within an associated housing that is generally compact and configured to be installed within the associated vehicle.

2. The compact antenna assembly according to claim 1 wherein the geometry of the meander line antenna trace is configured in a symmetrical dipole antenna.

3. The compact antenna assembly according to claim 1 wherein the geometry of the meander line antenna trace is configured in an asymmetrical antenna.

4. The compact antenna assembly according to claim 1 wherein the meander line antenna trace is connected to a radio frequency (RF) cable.

5. The compact antenna assembly according to claim 2 wherein the symmetrical meander dipole antenna further comprises a first trace arm and an opposing second trace arm that symmetrically extend along the dielectric substrate relative to each other.

6. The compact antenna assembly according to claim 5 wherein the symmetrical meander dipole antenna further comprises a first trace projection that extends from the first trace arm and an opposing second trace projection that extends form the second trace arm wherein the first trace arm and first trace projection and the second trace projection are generally symmetrical aligned to each other along the dielectric substrate.

7. The compact antenna assembly according to claim 3 wherein the asymmetrical meander dipole antenna further comprises a trace arm and a trace projection that extend substantially along the dielectric substrate.

8. The compact antenna assembly according to claim 1 wherein the dielectric substrate is a FR-4 type dielectric substrate.

9. The compact antenna assembly according to claim 4 wherein the RF cable is a RG 174 type coaxial cable.

10. The compact antenna assembly according to claim 1 herein the ratio of width to length of the dielectric substrate is less than 1.

11. The compact antenna assembly according to claim 1 wherein the meander line antenna trace has a width that is approximately 1 mm.

12. The compact antenna assembly according to claim 1 further comprising a ground spot that is configured to be used as an amplifier circuit.

13. The compact antenna assembly according to claim 1 wherein the meander line antenna trace has an impedance of approximately 50Ω.

14. A compact antenna assembly that is adapted to receive radio waves within the 200 MHz to 450 MHz frequency band, the antenna assembly comprising:
a meander line antenna trace of a desired geometry having a plurality of bends and strips that is configured to reduce the effect of electromagnetic interference; and
a dielectric substrate includes a length (L) and a width (W) that is configured to receive the antenna trace along a surface thereon;
wherein the dielectric substrate and antenna trace can be installed within an associated housing that is generally compact.

15. The compact antenna assembly according to claim 14 wherein the geometry of the meander line antenna trace is configured in a symmetrical dipole antenna.

16. The compact antenna assembly according to claim 15 wherein the bends and strips of the symmetrical dipole antenna are configured such that the addition of an RF cable does not have a significant effect on the performance of the antenna.

17. The compact antenna assembly according to claim 14 wherein the geometry of the meander line antenna trace is configured in an asymmetrical antenna.

18. The compact antenna assembly according to claim 17 wherein the bends and strips of the asymmetrical antenna are configured such that the addition of an RF has a significant effect on the performance of the antenna.

19. The compact antenna assembly according to claim 14 wherein the length of the meander line antenna trace is approximately 1/10 the length of a radio wave length in the 315 MHz frequency range.

20. The compact antenna assembly according to claim 14 wherein the compact antenna assembly is configured to be hidden within an associated vehicle for use in a remote control entry system.
